(19) United States
(12) Patent Application Publication
(10) Pub. No.: US 2008/0012370 A1
(43) Pub. Date: Jan. 17, 2008

(54) Moveable strip door suspension system

(75) Inventor: Thomas E. Brussard, Melrose, MA (US)

Correspondence Address: DOCKETING SPECIALIST;SULLIVAN & WORCESTER LLP, ONE POST OFFICE SQUARE, BOSTON, MA, 02109, US

(73) Assignee: Brussard Associates, Inc., Melrose, MA (US)

(21) Appl. No.: 11/486,679

(22) Filed: Jul. 14, 2006

(51) Int. Cl. B60N 3/00

(52) U.S. Cl. 296/24.41

(57) ABSTRACT

The present invention relates to movable barrier systems, such as a strip door suspension systems, that can be repositioned along the length or width of a room, container, or vehicle, for example, that is temperature controlled. The system saves energy, keeps cargo at a constant temperature, and is safe to the operator.

### FIELD OF THE INVENTION

The invention relates to moveable strip door suspension systems and methods that provide a barrier that moves along a rail and a roller track in a room or vehicle. The barrier may be positioned and releasably locked into position at any point along the rail/roller track system. In an embodiment, the barrier is a thermal barrier or insect barrier, for example.

### BACKGROUND OF THE INVENTION

Storing, transporting and delivering refrigerated goods requires the use of a room or vehicle equipped with a refrigeration or freezer unit or other means of cooling the air within the room or vehicle sufficiently to protect the cargo. One of the most obvious examples of such cargo is refrigerated or frozen foods or medical supplies which, if allowed to warm or thaw, are no longer useable or saleable.

If a vehicle is fully loaded at a single loading site and transported to an unloading site where it is fully unloaded, problems with respect to maintaining a sufficiently cool temperature are not necessarily encountered. However, when a vehicle is not fully loaded and/or is loaded at multiple loading sites and/or unloaded at multiple unloading sites, the risk of loss of refrigeration or increased expense for maintaining a proper refrigeration temperature increases. As delivery proceeds, the vehicle becomes partially emptied. This means that the refrigeration unit then cools not only the remaining cargo, but the empty portion of the vehicle. Each time the vehicle doors are opened and cargo is removed, cool air is lost and the warmer air that replaces it must then be cooled in order to protect the remaining cargo. As a consequence, cargo that is loaded first is also the cargo that is unloaded last and is thus subjected to the full effect of the warming and cooling cycles caused by repeatedly opening and closing the vehicle doors.

One approach to maintaining the cooling capacity of a refrigerated vehicle has been to provide a movable bulkhead that can be repositioned along the vehicle's length bulkhead is used to close off that portion of the vehicle that still contains refrigerated goods. However, rigid bulkheads are expensive, complex, difficult to position, heavy, and must be moved each time the goods contained behind them are loaded or unloaded. While some such bulkheads have doors that can be opened, a majority of bulkheads are solid and it is impossible to see precisely what is behind them without first moving them. Further, known bulkheads in the art feature heavy mounting hardware, and are hinged such that the entire bulkhead is lifted and then positioned along the roof of the vehicle when not in use. Such doors are difficult to repair and represent a potential safety hazard should the door hardware fail.

Strip curtains that span the width of a vehicle make it possible for a person to walk through the curtain without having to move it to one side and facilitate the on-loading and off-loading of cargo. However, where goods must be loaded in bulk, such as by forklift truck, it becomes extremely desirable to provide a way for the curtain to be moved from its position stretching across the load space to enable free access to the cargo or the cargo space. Without an easily operated structure to enable the movement of such a curtain along the vehicle length and across the vehicle width there is a tendency for the operator to use the strip curtain improperly.

Another approach to providing temperature control is a curtain or door, fashioned either from overlapping vinyl strips or insulating “blankets” consisting of fabric sandwiched around an insulating core. The strips or blankets are secured along a horizontally extending overhead member. Vinyl strips are made of lightweight translucent or transparent vinyl material, allowing the cargo behind the strips to be seen, while avoiding the storage and manipulation problems inherent in the use of heavy, rigid bulkheads. Such strip curtains have been modified for use in vehicles by providing a horizontally extending aluminum support member from which the individual strips are suspended, and a track-and-trolley extending along the upper walls of the vehicle proximate the roof, whereby the horizontally extending support member can be positioned at various specific sites along the length of the vehicle (see, for example, US Pat. No. 4,639,031 to Truckenbrodt). However, that patent discloses a locking system that can only engage with a series of holes placed at set intervals along the rail system it employs. In addition, the operator must undo the lock on one end of the system and pivot the system in order to move it to a different position in the vehicle. Such pivoting is difficult and dangerous if the operator is moving the system to the rear of a vehicle, because it requires the operator to leave the vehicle and step onto the ground, a docking board, scissor lift, or fork lift, thereby posing a safety issue. Another type of strip door, such as that manufactured by Kason Industries, is stationary and cannot be moved forward or backward inside a vehicle. Yet another system used in the past involves the permanent installation of a horizontal support member to the vehicle wall at a hinge which allows the strip curtain to be stored along the side wall of the vehicle, but does not allow the curtain to be repositioned along the length of the vehicle.

Accordingly, the need exists for a lightweight, ergonomically designed, low maintenance, and flexible thermally insulating barrier that may be positioned at any point along the length of a vehicle, thereby varying the air space required to be cooled, while at the same time providing structure that enables the barrier to be moved to a loading or storage position along side one of the trailer's side walls.

### SUMMARY OF THE INVENTION

The present invention relates to movable barrier systems that can be repositioned along the length or width of a room, building, container, or vehicle, for example, a truck, trailer, railroad car, aircraft hold, cart, or van. In an embodiment, the room, building, container, or vehicle is temperature controlled (e.g., refrigerated, freezing, or heated). The movable barrier systems and methods do not require pivoting of the barrier to reposition it, thereby making it safer and allowing the operator to stand within the trailer, for example, even when moving the barrier system to the rear of the vehicle. In addition, the movable barrier system provides a wider and higher insulated cargo space.

In one aspect, the invention provides movable barrier systems extendable between two side walls. The systems includes a barrier, a transverse bar engaged with the barrier such that the barrier extends between the two side walls, one end of the transverse bar moveably engaged with a first support and a second end of the transverse bar moveably engaged with a second support. The system further comprises a releasable locking mechanism engaged with the first end of the transverse bar and the first support such that the locking mechanism can lock onto the first support, for example, by clamping it. In an embodiment, the releasable locking mechanism can lock onto the first support at any point as it travels along the first support. In an embodiment, the transverse bar is moveable along the first and second support without the need to disengage it therefrom in order to move the barrier.

In an embodiment, the barrier is a thermal barrier (e.g., refrigeration or heat), such as a strip door or curtain; however any desired barrier, such as an insect barrier, is contemplated. In an embodiment, the barrier is formed from a plurality of strips, for example, thermoplastic sheeting or mesh. The barrier may be made of any suitable material, e.g., poly vinyl chloride, vinyl, and insulating fabric.

In an embodiment, the first support comprises a rail, such as an I or T rail, extending along the first side wall.

In an embodiment, the second support comprises a roller track extending along the second side wall. In an embodiment, the barrier system of the invention comprises a transverse bar that is engaged with a roller assembly that engages with the roller track. The roller assembly comprises at least one wheel.

In an embodiment, the locking mechanism comprises a moving member for releasing the locking mechanism. The release handle may be, for example, a wand, twist rod, chain, or rope.

### BRIEF DESCRIPTION OF THE DRAWINGS

The foregoing and other objects, features and advantages of the present invention, as well as the invention itself, will be more fully understood from the following description of preferred embodiments when read together with the accompanying drawings, in which:

FIG. 1 provides a perspective view of moveable strip door suspension system mounted on a trailer's side walls according to an embodiment of the invention.

FIG. 2 provides a perspective view of a moveable strip door suspension system according to an embodiment of the invention.

FIG. 3 provides a perspective view of the releasable locking mechanism according to an embodiment of the invention.

FIG. 4a provides a top view of the releasable locking mechanism in an open position according to an embodiment of the invention.

FIG. 4b provides a close up of the cam portion of the releasable locking mechanism of FIG. 4a in an open position according to an embodiment of the invention.

FIG. 5a provides a top view of the releasable locking mechanism in a closed position according to an embodiment of the invention.

FIG. 5b provides a close up of the cam portion of the releasable locking mechanism of FIG. 5a in a closed position according to an embodiment of the invention.

FIG. 6 provides a side view of a pivot mechanism that will allow the strip door of the invention to be moved to a side of the container or truck.

FIG. 7 provides a perspective view of a pivotable strip door suspension system according to an embodiment of the invention.

### DETAILED DESCRIPTION OF THE INVENTION

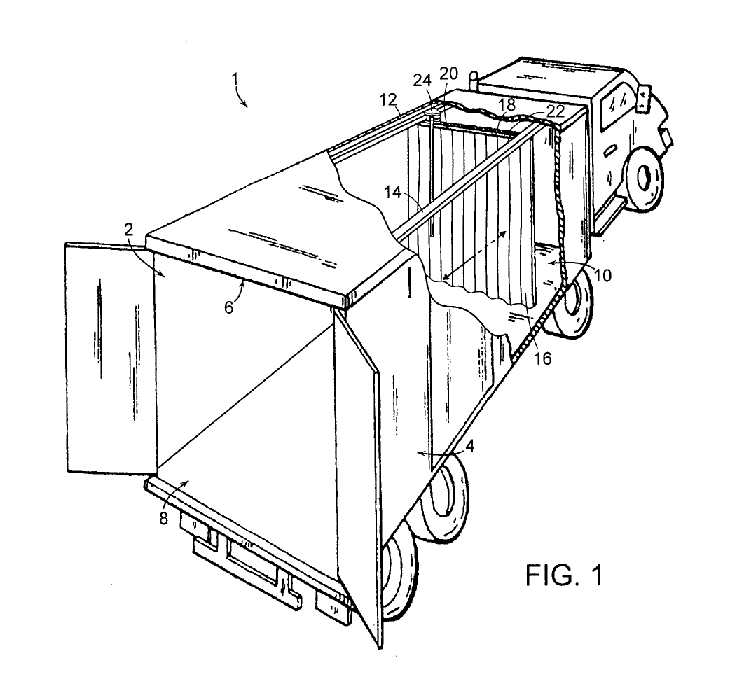

FIG. 1 shows an embodiment of the invention comprising a trailer truck 1 with a temperature control unit (not specifically shown) for keeping the interior of the trailer truck I at a uniform temperature (e.g., cool or hot). The trailer truck 1 has a left (first) side wall 2, a right (second) side wall 4, a ceiling 6, and a floor 8. As shown in FIG. 1, a moveable strip door suspension system 10 according to one embodiment of the invention is installed therein. The system 10 comprises a first support 12 disposed on the left side wall 2, a second support 14 disposed on the right side wall 4, a strip door 16 attached to a transverse bar 18, having a first end 20 and a second end 22, disposed there between, and a releasable locking mechanism 24 for locking the transverse bar 18 in a desirable place along the first and second supports 12, 14. The transverse bar 18 is moveable in both the forward and backward directions and can be locked in place using the releasable locking mechanism 24, and unlocked and moved as desired.

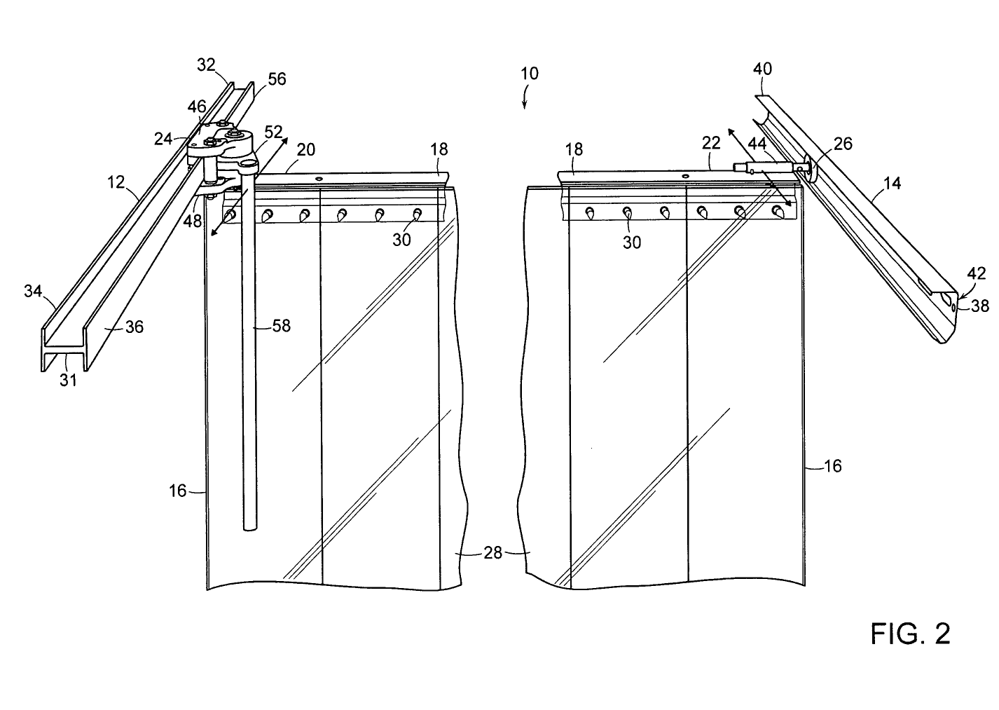

Referring now to FIG. 2, the first support 12 is arranged in a fixed parallel spatial relationship with the second support 14, along the left and right side walls 2, 4. In an embodiment, the first support 12 is an I rail and the second support 14 is a roller track. As shown in FIG. 1, in an embodiment, the first and second supports 12, 14 are placed proximal to the ceiling 6, such that the amount of temperature controlled (e.g., cool) air escaping over the strip door 16 is minimized. If desired, additional strip door material or other suitable barrier (not shown) can be attached to the transverse bar 18 or strip door 16 such that it extends upward toward the ceiling 6 to further block the escape of temperature controlled air from the temperature controlled section of the trailer truck 1.

The first support 12 may be any suitable shape for allowing traversal by a releasable locking mechanism 24. In certain embodiments, the first support 12 may be an I rail, a T rail, beam, cable, or the like. The first support 12 may be made of any suitably rigid material that can withstand the weight and movement stresses of the strip door 16, for example, metal (e.g., aluminum, stainless steel, galvanized steel, HTP ®), plastic, fiberglass, poly vinyl chloride, or the like. In an embodiment, the first support 12 further comprises apertures for bolting or screwing the first support 12 to the left side wall 2 (not shown).

The second support 14 may be any suitable shape for allowing traversal by a roller 26 attached to the transverse bar 18. In certain embodiments, the second support 14 may be a C rail. In other embodiments, the second support 14 is a trolley selected from a flat trolley or an eye manual trolley (e.g., as sold by Vestil Manufacturing Corporation, Angola,Ind.) or a track or the like, such as those sold by Richards-Wilcox, Inc. (Aurora, Ill.). The second support 14 may be made of any suitably rigid material that can withstand the weight and movement stresses of the strip door 16, for example, aluminum, stainless steel, galvanized steel, HTP® , plastic, fiberglass, poly vinyl chloride, or the like. In an embodiment, the second support 14 further comprises holes for bolting or screwing the second support 14 to the right side wall 4.

In another embodiment, the orientation of the moveable strip door suspension system 10 is reversed such that the first support 12 is secured to the right side wall 4 and the second support 14 is secured to the left side wall 2. Alternatively, the moveable strip door suspension system 10 is positioned along the length of the vehicle 1, for example, if the door is located on the side of the vehicle.

The strip door 16 may be attached to the transverse bar 18 by any number of securing means. FIG. 2 shows an embodiment of the invention in which the strip door 16 comprises a number of strips 28 that are attached to the transverse bar 18 by a plurality of bullet shaped members 30, for example, as in the Maximus System™or MaxBullet™mounting hardware sold by Aleco Corp. (Muscle Shoals, Ala.). Any alternative attachment is contemplated, including hooks, buttons, staples, rings, nuts and bolts, welded studs, or the like. The transverse bar 18 may be made of any suitably rigid material that can withstand the weight and movement stresses of the strip door 16, for example, aluminum, stainless steel, galvanized steel, HTP®, plastic, fiberglass, poly vinyl chloride, or the like.

The strips 28 and strip door 16 may be any desired width or length to span a desired space. For example, the strips 28 may be about 2, about 4, about 6, about 8, about 10, about 12, about 14, about 16, about 20, about 25, about 30, about 35, about 40, about 45, about 50, about 55, about 60, about 65, about 70, about 75, about 80, about 85, about 100, inches in width or any width there between. The strips 28 may be any suitable length depending on the height of the room, container or vehicle, for example, about 2 feet, about 4 feet, about 6 feet, about 8 feet, about 10 feet, about 12 feet, about 14 feet, about 16 feet, or any length there between.

The strips 28 may be made of any useful thermal material, such as, for example, polyvinylchloride, vinyl, vinyl coated fabric, high mass vinyl, pre-coated woven vinyl coated mesh polyester screen, and insulating fabric, and may be clear, opaque, or any desired color, texture, or dimensions. The strips 28 may be any desired thermally insulating thickness, for example, about 0.040, about 0.050, about 0.10, about 0.15, about 0.20, about 0.25, about 0.30, about 0.35, about 0.40, about 0.45, or about 0.50 mm or any thickness there between. Suitable strip 28 material includes, for example, Clear-Flex II®, Hi-Viz®, and Scratch Guard®by Aleco Corp. (Muscle Shoals, Ala.) or Standard Smooth, USDA Low-Temp Smooth, USDA Low-Temp Reinforced, Anti-Static, Weld Screen, Opaque, Safety Orange, X-Low-Temp sold by Kason Industries, Inc. (Lynbrook, N.Y.) or strip doors such as Save-T o sold by TMI Inc. (Pittsburgh, Pa.), Verilon® Vinyl (Wheeling, Ill.), or those sold by Singer Safety Co. (Chicago, Ill.), Wilson Industries (Pomona, Calif.), or Strip-Curtains.com (Point Roberts, Wash.), for example. Alternatively, the strips 28 or strip door 16 may be comprised of a material (e.g., mesh strips) that keeps insects out of a portion of the trailer 1. In an embodiment, the insect strips 28 are mesh strips made of pre-coated woven vinyl coated mesh polyester screen, such as Air-Flex®, sold by Aleco Corp. (Muscle Shoals, Ala.).

Referring again to FIG. 2, an embodiment of the movable strip door suspension system 10 is shown in more detail. In an embodiment, the first support 12 is I shaped and comprises a first end 31 and a second end 32 comprising a first side 34 and a second side 36. The first side 34 of the first support 12 is placed against the left side wall 2 and the second side 36 engages with the releasable locking mechanism 24. The second support 14 is C shaped and comprises a first end 38 and a second end 40 and a side 42 that is placed against the right side wall 4. The second support 14 is engaged with a roller 26, for example, such as the rollers sold by Action Industries (Cleveland, Ohio). In an embodiment, the roller 26 may be a utility hanger, caged roller bearing, ball bearing, or the like, such as those sold by Richards-Wilcox, Inc. (Aurora, Ill). The roller 26 is rotatably engaged with a bracket 44 that is attached to the second end 22 of the transverse bar 18 and the first end 20 of the transverse bar 18 is attached to the releasable locking mechanism 24.

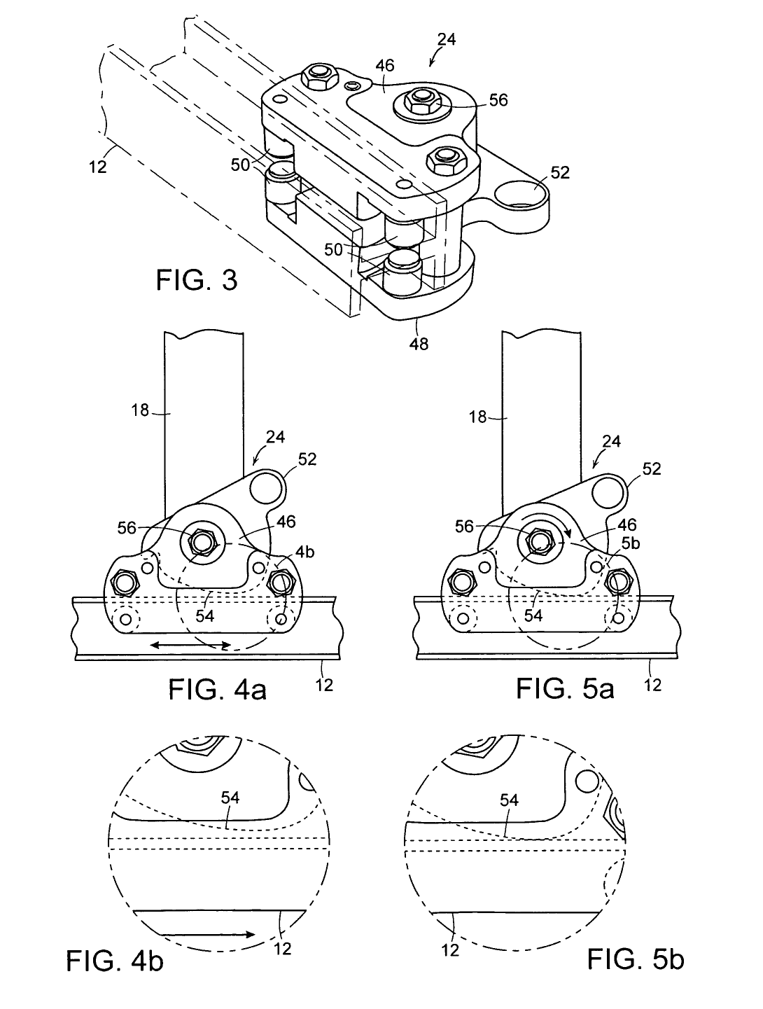

Referring now to FIG. 3, in an embodiment of the invention, the releasable locking mechanism 24 clamps onto the first support 12 and is moveable anywhere along the first support 12 between the ends 31, 32. In an embodiment, the releasable locking mechanism 24 is a brake mechanism such as those described in U.S. Pat. Nos. 3,348,632 and 5,238,084 to Swager relating the Climber's Buddy™ sold by Sur Loc, Inc. (Fremont, Ind.) and U.S. Patent Application No. 20030217887 to Thomas. The releasable locking mechanism 24 may be spring-biassed into frictional engagement with the first support member 12. The releasable locking mechanism 24 may be a clamp, such as a girder clamp, a universal superclamp, a swivel or fixed jaw adjustable girder clamp, for example (i.e., as sold by Fastenal, Winona, Minn.), or the like, or other clip, cam, or lock that can move along a track and lock in place along the track.

Referring to FIGS. 3-5b, in an embodiment of the invention, the releasable locking mechanism 24 comprises side plates 46, 48, between which are disposed rollers 50 and a locking arm 52 comprising a cam 54. The rollers 50 and the locking arm 52 of the releasable locking mechanism 24 are spaced to engage an H rail 12 and to allow for locking engagement with the cam 54. In an embodiment, a spring (not shown) is mounted on each side of locking arm 52, biasing the cam 54 against the H rail 12. A bolt 56 passes through the side plates 46, 48 to secure the releasable locking mechanism 24 to the transverse bar 18. FIGS. 4a and 4b show a releasable locking mechanism 24 in the open position, in which the cam 54 is not pressing against the H rail 12, and can be moved along the H rail 12 in either direction. FIGS. 5a and 5b show the releasable locking mechanism 24 in the locked position, in which the cam 54 is engaged with and locked against the H rail 12.

Referring again to FIG. 2, in an embodiment, the releasable locking mechanism 24 further comprises a moving member 58 for use by the operator to grasp and push or pull to open and close the releasable locking mechanism 24. In an embodiment, the moving member 58 is a wand, a twist rod, a chain, or a rope, for example. In another embodiment, the moving member 58 is a cargo bar or cargo strap that is already in the trailer for keeping the trailer contents securely in place (e.g., those sold by Vestil Manufacturing Corp., Angola, Ind.). The moving member 58 is useful for moving the strip door 16 forward and backward along the first and second supports 12, 14.

Referring now to FIGS. 1-3, the strip door 16 is initially positioned at a desired location within a vehicle 1, with transverse bar 18 secured to the first support 12. When it is desired to move the transverse bar 18 along the length of vehicle 1, the releasable locking mechanism 24 is opened by moving the locking arm 52 either by hand or using a moving member 58, for example. While holding the locking arm 52 in the open position as shown in FIGS. 4a and 4b, the releasable locking mechanism 24 may be moved along the first support 12 and second support 14 to a second desired position, where the locking arm 52 is released and locks in place (FIGS. 5a and 5b). The strip door 16 can be moved with minimum force, allowing a user to move the strip door 16 closer to the goods requiring refrigeration, freezing, or heating. In another embodiment, the releasable locking mechanism 24 is moved along the first support 12 pneumatically, according to art known methods, by operation either directly on or around the moveable strip door suspension system 10, or remotely, e.g., in the cab of a truck by the driver.

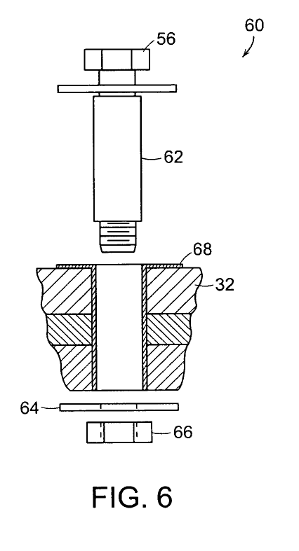

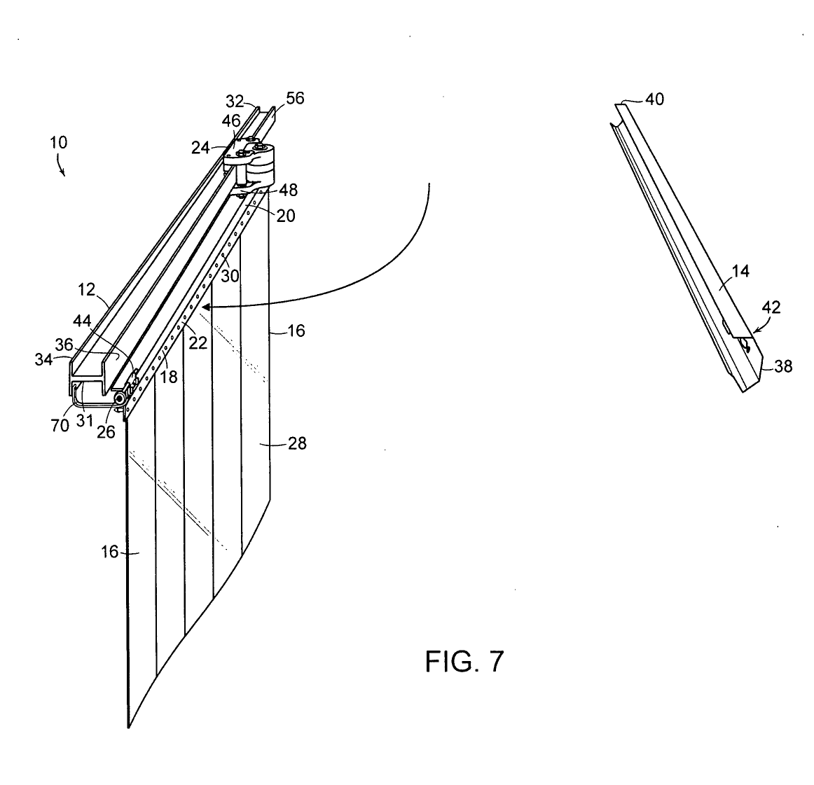

Although not required to release or move the movable strip door suspension system 10 of the invention along the first support 12 and second supports 14, as it is for the system disclosed in U.S. Pat. No. 4,639,031, in some circumstances the operator may desire to move the strip door 16 to one side of the container or vehicle 1. In an embodiment, the strip door 16 can be swung out of the way to simplify loading and unloading, in a similar manner to the “The Swinger” produced by Randall Manufacturing (Elmhurst, Ill.). Referring now to FIG. 6, the releasable locking mechanism 24 may comprise a hinge mechanism 60 that allows the transverse bar 18 to pivot so that it can be moved to one side of the vehicle. In an embodiment, a pivot hinge mechanism 60 may be provided by making bolt 56 about 0.5 to about 2 inches longer to allow for a nylon sleeve 62, such as a DryLin® S anodized aluminum shafting or the like, as sold by Igus, Inc. (East Providence, R.I.), to be inserted through transverse bar 18 and fastened with a washer 64 and lock nut 66. A spanner bushing 68, such as those sold by Refrigeration Hardware Supply Corp. (Sun Valley, Calif.) or Graphite Metallizing Corp. (Yonkers, N.Y.) will be placed into the hole through which the bolt 56 passes in the transverse bar 18, allowing the bolt 56 to rotate within the bushing 68.

Referring now to FIG. 7, in an embodiment, the first end 38 of the second support 14 is open such that when the roller 26 reaches the first end 38 it travels off the second support 14 and can pivot relative to bolt 56 to be placed along the first side 2 of the vehicle 1. In another embodiment, an opening can be placed at any point along the length of the second support 14 in order to release and pivot the transverse bar 18 at another location along the second support 14.

In an embodiment, the strip door 16 is pivoted and then secured to a wall of the container or truck, for example, using a wire form hook 70 such as a bent wire hook, S hook, conveyor hook, wire hold down hook, hanging wire form hook, or the like, such as those sold by Marlin Steel Wire Products (Baltimore, Md.) or Keyspan (Fort Lauderdale, Fla.) or other securing device, such as a tie, snap, bolt, bullet fastener, or the like.

One of the many advantages of the invention is that, compared to the device disclosed in U.S. Pat. No. 4,639,031, the transverse bar 18 of the moveable strip door suspension system 10 is closer to the ceiling 6, providing more clearance for loading goods, especially given the angle at which they are loaded from the back of a truck using an angled dockboard. The moveable strip door suspension system 10 can also travel the entire length of a vehicle 1 without requiring the operator to disembark from the vehicle. Further, the instant invention also has the added advantage of providing more usable space for cargo, because it does not include the bar locking assembly of the system disclosed in U.S. Pat. No. 4,639,031.

### Incorporation by Reference

The contents of all cited references (including literature references, patents, patent applications, and websites) that may be cited throughout this application are hereby expressly incorporated by reference. The practice of the present invention will employ, unless otherwise indicated, conventional techniques of strip door manufacturing, which are well known in the art.

### Equivalents

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes that come within the meaning and range of equivalency of the claims are therefore intended to be embraced herein.

We claim:

1. A movable barrier system extendable between a first side wall and a second side wall, the system comprising:
a barrier;
a transverse bar comprising a first end and a second end, the transverse bar engaged with the barrier;
a first support disposed on a first side wall and a second support disposed on a second side wall, wherein the first end of the transverse bar is moveably engaged with the first support and the second end of the transverse bar is moveably engaged with the second support; and
a releasable locking mechanism engaged with the first end of the transverse bar and the first support such that the locking mechanism can lock onto the first support by clamping the first support.

2. A movable barrier system extendable between a first side wall and a second side wall, the system comprising:
a barrier;
a transverse bar comprising a first end and a second end, the transverse bar engaged with the barrier;
a first support disposed on a first side wall and a second support disposed on a second side wall, wherein the first end of the transverse bar is moveably engaged with the first support and the second end of the transverse bar is moveably engaged with the second support; and
a releasable locking mechanism engaged with the first end of the transverse bar and the first support such that the locking mechanism can lock onto the first support at any point on the first support as it travels along the first support.

3. A movable barrier system extendable between a first side wall and a second side wall, the system comprising:
a barrier;
a transverse bar comprising a first end and a second end, the transverse bar engaged with the barrier;
a first support disposed on a first side wall and a second support disposed on a second side wall, wherein the first end of the transverse bar is moveably engaged with the first support and the second end of the transverse bar is moveably engaged with the second support; and
a releasable locking mechanism engaged with the first end of the transverse bar and the first support, the locking mechanism moveable along the first and/or second support without disengagement therefrom.

4. The system according to claim 1, wherein the barrier is a thermal barrier.

5. The system according to claim 1, wherein the barrier is an insect barrier.

6. The system according to claim 1, wherein the barrier is formed from a plurality of strips.

7. The system according to claim 6, wherein the strips comprise thermoplastic sheeting.

8. The system according to claim 6, wherein the strips comprise a mesh.

9. The system according to claim 1, wherein the barrier comprises a material selected from the group consisting of poly vinyl chloride, vinyl, and vinyl coated fabric.

10. The system according to claim 4, wherein the thermal barrier comprises an insulating fabric.

11. The system according to claim 1, wherein the first support comprises an I rail extending along the first side wall.

12. The system according to claim 1, wherein the first support comprises a T rail extending along the first side wall.

13. The system according to claim 1, wherein the second support comprises a roller track extending along the second side wall.

14. The system according to claim 1, wherein the second end of the transverse bar is engaged with a roller assembly that engages with the roller track.

15. The system according to claim 1, wherein the second end of the transverse bar can disengage from the roller track.

16. The system according to claim 14, wherein the roller assembly comprises at least one wheel.

17. The system according to claim 14, wherein the transverse bar can pivot to be moved to be against the first side wall.

18. The system according to claim 1, wherein the locking mechanism comprises a moving member for moving the locking mechanism.

19. The system according to claim 1, wherein the system is attached to the inside of a vehicle selected from the group consisting of a truck, a trailer, an aircraft, a cart, a van, and a train car.

20. The system according to claim 1, wherein the system is attached to the inside of a room or container.

21. A method for altering the temperature controlled space in a vehicle, container, or room, the method comprising the steps of:
(a) releasing a movable barrier extending between a first side wall and a second side wall of a vehicle, container, or room, wherein the movable barrier comprises
(i) a barrier,
(ii) a transverse bar comprising a first end and a second end, the transverse bar engaged with the barrier, wherein the transverse bar is movably engaged with a first support disposed on the first side wall and a second support disposed on the second side wall, and
(iii) a releasable locking mechanism engaged with the first end of the transverse bar and the first support such that the locking mechanism can lock onto the first support; and
(b) moving the movable barrier along the first and second supports to a different location along the first and second side walls.

22. The method according to claim 21, further comprising the step of locking the releasable locking mechanism in place after the moving step.

23. The method according to claim 21, wherein the releasable locking mechanism is locked onto the first support at any point along its length.

24. The method according to claim 21, wherein the releasable locking mechanism clamps onto the first support.

25. The method according to claim 21, wherein the transverse bar does not disengage with the second support before, during, or after the moving step.

26. The method according to claim 1, wherein the transverse bar disengages with the second support to be pivoted and placed parallel to the first side wall.
